(19) United States
(12) Patent Application Publication
(10) Pub. No.: US 2007/0122339 A1
(43) Pub. Date: May 31, 2007

(54) Methods and apparatus for hydrogen production

(75) Inventors: Parag Kulkarni, Tustin, CA (US); Richard Bourgeois, Albany, NY (US); Ke Liu, Rancho Santa Margrita, CA (US); Ravi Kumar Sathya Vipperla, Irvine, CA (US); Vladimir Zamansky, Oceanside, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/287,644

(22) Filed: Nov. 28, 2005

(51) Int. Cl. C01B 3/26; C25C 1/02; B01J 8/04; C25B 9/00

(52) U.S. Cl. 423/652; 205/628; 422/189; 204/265

(57) ABSTRACT

An apparatus for producing hydrogen (H2) includes an electrolyzer configured to produce H2 gas from steam and a catalytic partial oxidation (CPO) reformer. The CPO reformer is coupled to the electrolyzer and configured to utilize byproducts of the electrolyzer as input to produce more H₂. The electrolyzer is coupled to the CPO reformer to utilize steam and heat byproducts from the CPO reformer as input to the electrolyzer.

### BACKGROUND OF THE INVENTION

This invention relates generally to hydrogen production, and more specifically to methods and apparatus for generating hydrogen that can accommodate a varying demand.

One of the challenges to realization of the hydrogen economy is development of a low-cost hydrogen production technology that can meet a varying demand for hydrogen (e.g., at a refueling station). During an initial phase of a hydrogen economy, variations in hydrogen demand will make the choice of reforming technology challenging.

Electrolysis of water to produce H₂ is clean, but highly energy intensive, typically requiring 50 kilowatt hours of power for every kilogram of hydrogen produced. Most electrolyzers utilize electrical power almost exclusively to split liquid water into H₂ and O₂. At least one known recent electrolyzer design operates with steam. In the latter electrolyzer, less electric power is used because a portion of the energy required to split steam into H₂ and O₂ comes from the heat energy of the steam itself. Also, a byproduct of electrolysis is O₂, which is typically vented to the atmosphere, as it is not economical to capture, store, and sell it.

Catalytic partial oxidation (CPO) is a promising reforming technology for H₂ production from natural gas (NG) or other carbon containing fuel including, but not limited to, ethanol, methanol, etc. The use of pure O₂ instead of air can advantageously result in compact reactors and can reduce or eliminate H₂ clean up systems. However, the use of pure O₂ dictates the use of an air separation unit (ASU), resulting in higher capital costs because the ASU is one of the most expensive units in contemporary H₂ or GTL (gas to liquid) plants. Also, there is excess heat available in CPO reforming that is not utilized in the reforming process when air is used as a source of O₂, thus reducing the overall efficiency of CPO reforming.

### BRIEF DESCRIPTION OF THE INVENTION

Therefore, the present invention, in one aspect, provides a method for producing hydrogen (H₂). The method includes utilizing an electrolyzer to produce H₂ gas from steam, mixing byproducts of the electrolyzer and hydrocarbon fuel, and utilizing a catalytic partial oxidation (CPO) reformer to produce CO and H₂ from the mixed byproducts and hydrocarbon fuel. The method further includes removing the CO and remaining steam from the produced CO and H₂, to thereby produce additional H₂.

In another aspect, the present invention provides a method for producing hydrogen (H₂) that includes utilizing an electrolyzer to produce H2 gas from steam, utilizing byproducts of the electrolyzer as input to a catalytic partial oxidation (CPO) reformer to produce more H₂, and utilizing steam and heat byproducts from the CPO reformer as input to the electrolyzer.

In yet another aspect, the present invention provides an apparatus for producing hydrogen (H₂). The apparatus includes an electrolyzer configured to produce H₂ gas from steam and a catalytic partial oxidation (CPO) reformer. The CPO reformer is coupled to the electrolyzer and configured to utilize byproducts of the electrolyzer as input to produce more H₂. The electrolyzer is coupled to the CPO reformer to utilize steam and heat byproducts from the CPO reformer as input to the electrolyzer.

It will be seen that configurations of the present invention can provide a single hydrogen production system generating H₂ at a variable scale, dependent upon demand. Also, a compact reformer can be used because O₂ is used instead of air as the oxidant and there is no N₂ dilution. The lack of N₂ dilution also results in easy and economical H₂ separation and purification, and in many configurations, no pressure swing adsorption unit (PSA) is required. Furthermore, in many configurations, high-pressure electrolysis eliminates the need for an expansive O₂, air or a syngas compressor.

### BRIEF DESCRIPTION OF THE DRAWING

FIG. 1 is a diagrammatic representation of a configuration of the present invention.

FIG. 2 is a diagrammatic representation of another configuration of the present invention similar to the configuration shown in FIG. 1 in which no external steam generation is needed.

FIG. 3 is a diagrammatic representation of yet another configuration of the present invention in which an amine-based solvent is used to absorb and remove CO₂ from the product stream.

FIG. 4 is a diagrammatic representation of yet another configuration of the present invention in which a pressure swing absorber (PSA) is used to separate H₂ from other reaction products.

FIG. 5 is a diagrammatic representation of another configuration of the present invention similar to that illustrated of FIG. 4, but in which the PSA off gas is compressed and combusted in a microturbine to generate electricity to drive an H₂ compressor.

### DETAILED DESCRIPTION OF THE INVENTION

Some configurations of the present invention provide a hydrogen generator that combines electrolysis and catalytic partial oxidation (CPO) reforming. A compact electrolyzer uses the excess steam from the reformer to produce H₂ and O₂. The O₂ produced is mixed with a hydrocarbon fuel (which can be, by way of example and not by way of limitation, natural gas, methanol, ethanol, methane, ethane, propane, gasoline, or diesel, or a mixture thereof) and steam and sent to a CPO unit to produce syngas (CO+H₂). (As used herein, a “hydrocarbon fuel” is a combustible fuel having as products of its complete combustion only CO₂ and H₂O, exclusive of any impurities.) This syngas is sent to a shift reactor to convert the CO and steam to CO₂ and H₂. The shift reactor can be tuned to produce less than 0.5% CO in the outlet of the shift reactor. Any remaining CO will be converted to CO₂ using a small preferential oxidation (PrOx) catalyst with a small stream of O₂ coming out of the electrolyzer. A product stream containing H₂, CO₂, and steam is compressed. The H₂O and CO₂ is condensed and removed as liquid during the compression and a pure H₂ product is compressed and stored at about 5000 to 10000 psi for refueling purposes.

Configurations of the present invention utilize byproducts of each technology (O₂ from electrolysis and excess heat and steam from CPO) to improve the efficiency of the combined system (e.g., 39% efficiency vs. 22% for electrolysis only, lower heating value basis). Some unit operations such as the air separation unit, air/O₂ compressor and pressure swing adsorption (PSA) can be eliminated to reduce the capital cost of the combined system. In some configurations, typically 30% of the full scale load of H₂ will be generated using the electrolyzer and the remaining H₂ will be generated using the CPO reformer.

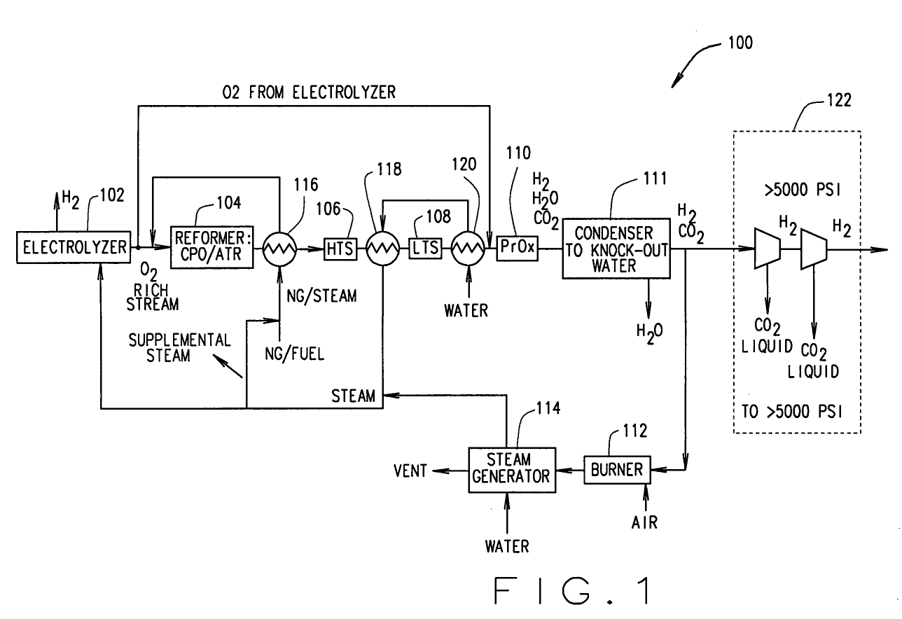

In some configurations and referring to FIG. 1, an apparatus 100 for producing hydrogen (H₂) is provided. The apparatus includes an electrolyzer 102 configured to produce H₂ gas from steam. For example, electrolyzer 102 can utilize liquid water electrolysis supplying O₂, a proton exchange membrane (PEM) stream electrolyzer supplying O₂ and using steam at about 100° C. to 300° C., or a solid oxide electrolyzer (SOEC) supplying O₂ and using steam at about 600° C. to 800° C. Also provided is a catalytic partial oxidation (CPO) reformer 104 that is coupled to electrolyzer 102 and configured to utilize byproducts of the electrolyzer as input such that apparatus 100 thus produces more H2. Also, electrolyzer 102 is coupled to CPO reformer 104 (albeit indirectly in the configuration illustrated in the Figure) to utilize steam and heat byproducts from CPO reformer 104 as input to electrolyzer 102. In some configurations, electrolyzer 102 is configured to produce about 30% of the full-scale load of hydrogen produced by apparatus 100. In this particular context, “about 30%” is intended to mean between 10% and 50%, inclusive. However, in some configurations, electrolyzer 102 is configured to produce between 10% and 80% of the full scale load of hydrogen. Because of the reuse of byproducts, apparatus 100 can be configured to operate at about 39% efficiency LHV. (“About 39%” in this particular context is intended to mean between 35% and 45% efficiency, inclusive, on an LHV basis.)

Some configurations of the present invention also include a multi-stage compression that condenses and removes H₂O and CO₂ as liquid, and compresses and stores generated H₂ at 5000 to 10,000 PSI for refueling purposes.

Also in some configurations, apparatus 100 is further configured to mix byproducts of electrolyzer 102 with hydrocarbon fuel, utilize CPO reformer 104 to produce CO and H2 from the mixed byproducts and hydrocarbon fuel and utilize a shift converter (which, in apparatus 100, comprises a high temperature shift converter 106 and a low temperature shift converter 108) to remove the CO and remaining steam from the produced CO and H₂ from CPO reformer 104. A PrOx catalyst bed 110 is coupled to shift converter 108 and is configured to utilize a stream of O₂ to convert the CO to CO₂, since CO requires much higher pressure to condense to a liquid for separating from the H₂ stream. A condenser 111 is used on the output stream of H₂, H₂O, and CO₂ to remove the H₂O from the stream.

Some configurations of the present invention are also configured to mix O₂ and steam with the byproducts of electrolyzer 102. This mixing is accomplished in apparatus 100 of FIG. 1 by mixing air or O₂ with the output of PrOx catalyst bed 110 or the output of condenser 111, feeding the mixture into a burner 112, and feeding the output of burner 112 along with water into a steam generator 114. The output of steam generator 114 includes steam, which is fed into electrolyzer 102, which, in some configurations, is not only configured to generate about 30% of the full scale load of H₂, but nay also be further configured to utilize excess steam and heat generated by CPO reformer 104. In addition, part of the steam is generated by heat exchangers 116, 118, and 120. Reformer 104 outlet temperature is between about 700° C. and 1000° C., and low temperature shift reactor 108 outlet temperature is between about 150° C. and 300° C. Steam is generated by cooling the process syngas from reformer 104 outlet temperature to shift 118 and/or 120 outlet temperature. A multistage compressor 122 can be used to liquify CO₂ at each stage, resulting in an output of nearly pure hydrogen at a pressure of greater than 5000 PSI. Also advantageously in this configuration of apparatus 100 is that a portion of the O₂ produced by electrolyzer 102 goes to PrOx reactor 110 for oxidation of CO to CO₂.

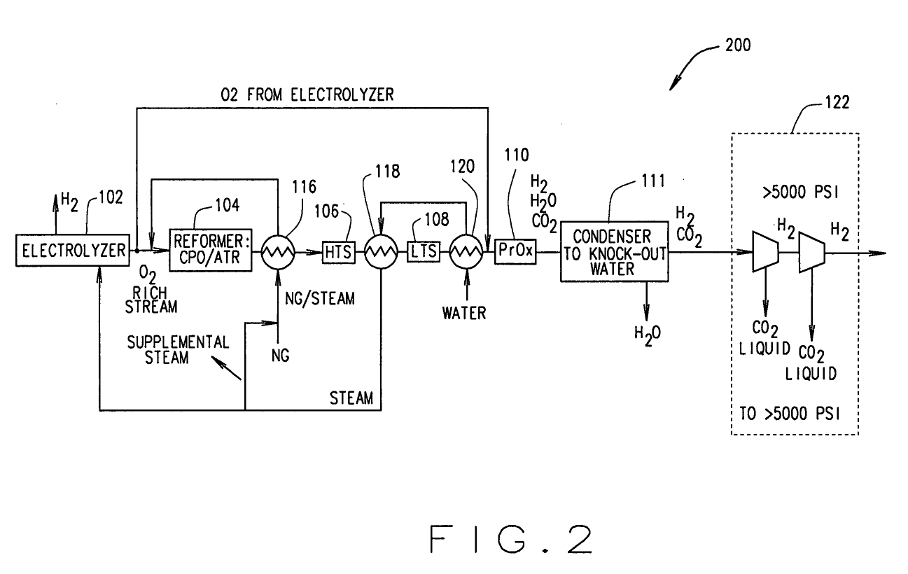

Referring to FIG. 2, some configurations 200 of the apparatus do not require external steam generation. All the steam require for configuration 200 is generated in heat exchangers 116, 118, and 120 around reformer 104 and shift reactors 106, 108.

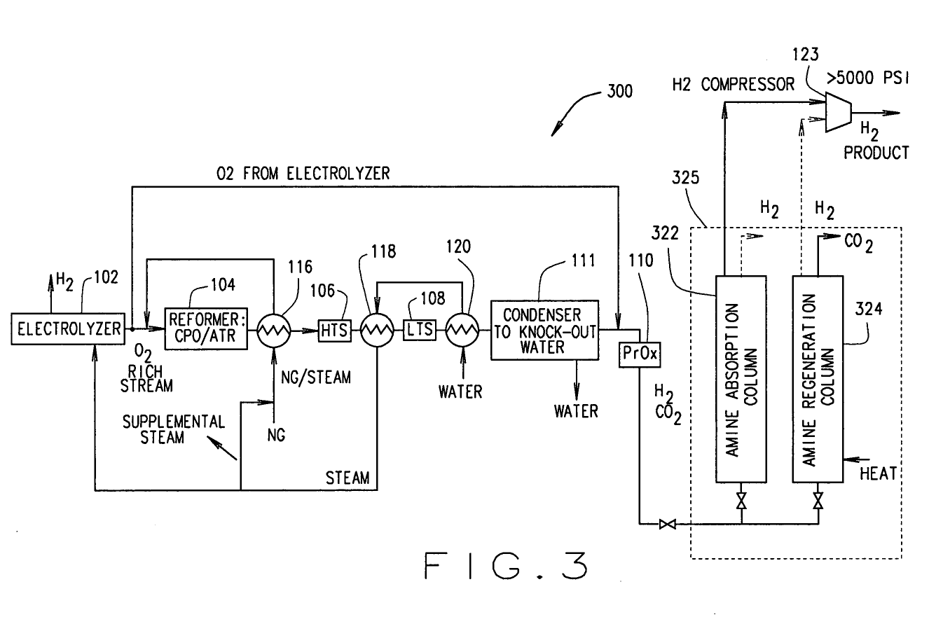

Referring to FIG. 3, some configurations 300 of the present invention utilize amine based solvent absorption system 325 columns 322, 324 to absorb and remove CO₂ from the product stream. One column 322 of absorption system 325 absorbs CO₂ and another column 324 is used for regeneration of solvents by heating. The H₂ coming out of absorption column 322 is further compressed by a hydrogen compressor 123 for storage.

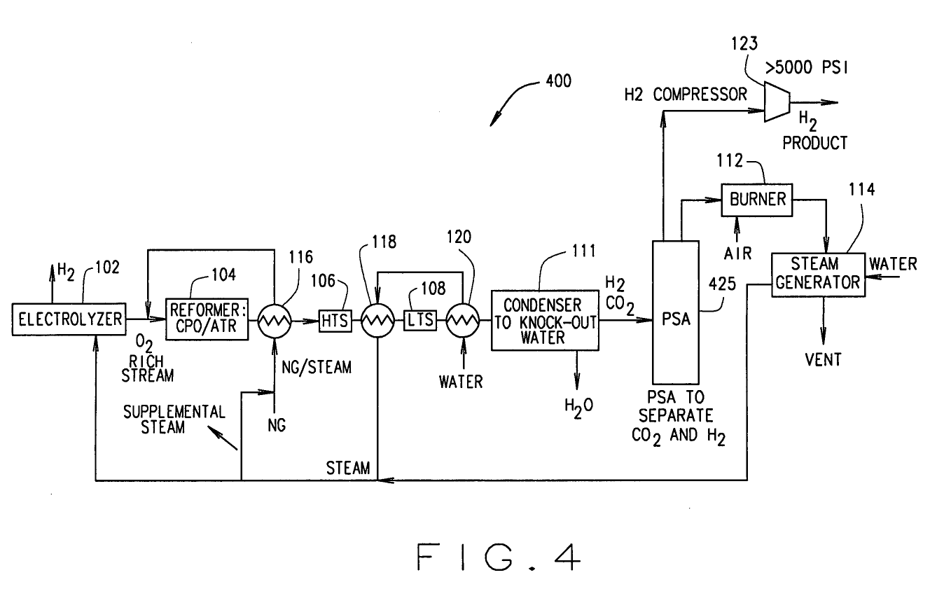

Referring to FIG. 4, some configurations 400 of the present invention utilize a pressure swing absorber (PSA) 425 to separate H₂ from the remaining products instead of a PrOx, a multistage compressor, or an amine-based absorption system. A typical PSA generates greater H₂ with a purity greater than 99% with about 80% recovery. The product H₂ gas is further compressed to greater than 5000 PSI in a hydrogen compressor. PSA off gas containing H₂, CO, CO₂ and some fuel can be burned in a burner 112 to generate energy to produce additional steam.

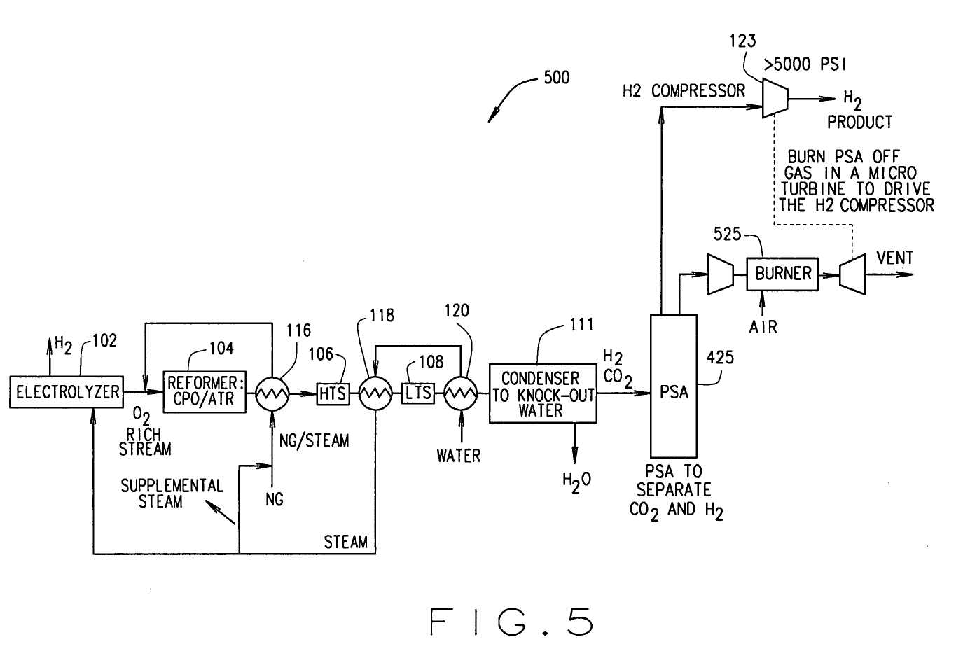

Referring to FIG. 5, in some configurations 500 of the present invention, the PSA off gas is compressed and combusted in a microturbine 525 to generate energy to produce electricity to drive H₂ compressor 123.

It will thus be appreciated that configurations of the present invention can provide a single reforming system that generates H₂ at variable scales dependent upon demand. Also, configurations of the present invention can provide a compact reformer because there is no N₂ dilution, and can also provide simple H₂ purification. For example, in the case of fueling stations, 5000-10,000 psig of H₂ may be needed. If there is no N₂, at an end of the reformer, there will be only H₂, CO₂ and steam. Steam and CO₂ can be condensed while compressing H₂, so PSA could be eliminated. Also, high-pressure electrolysis eliminates the need for an O₂ compressor.

In some configurations of the present invention and again referring to the Figure, a method for producing hydrogen (H₂) is provided. The method includes utilizing an electrolyzer 102 to produce H₂ gas from steam, mixing byproducts of electrolyzer 102 and hydrocarbon fuel, utilizing a catalytic partial oxidation (CPO) reformer 104 to produce CO and H₂ from the mixed byproducts and hydrocarbon fuel and converting the CO and remaining steam from the produced CO and H₂, to thereby produce additional H₂ from apparatus 100. Apparatus 100 can be referred to as a Water-Gas-Shift reactor.

In some configurations, removing the CO and remaining steam further comprises utilizing a PrOₓ catalyst bed 110 with a small stream of O₂ produced by electrolyzer 102 to remove the CO. Removing the CO and remaining steam can comprise utilizing a shift reactor 108 to convert CO to CO₂.

In some configurations of the present invention, the byproducts of the electrolyzer that are mixed with the hydrocarbon fuel comprise O₂ and steam. In some configurations, about 30% of the H₂ generated by apparatus 100 is generated by electrolyzer 102.

In some configurations, excess steam and heat generated by CPO reformer 104 is utilized in electrolyzer 102.

Also, in some configurations of the present invention, a method for producing hydrogen (H₂) is provided that includes utilizing an electrolyzer 102 to produce H₂ gas from steam, utilizing byproducts of electrolyzer 102 as input to a catalytic partial oxidation (CPO) reformer 104 to produce more H₂, and utilizing steam and heat byproducts from CPO reformer 104 as input to electrolyzer 102. In some of these configurations, about 30% of the hydrogen produced by apparatus 100 is generated by electrolyzer 102. Also, about 39% efficiency is achieved in some configurations on an LHV basis. Some configurations further include condensing and removing H₂O and CO₂ as liquid, and compressing and storing generated H₂ at 5000-10,000 PSI.

It will thus be appreciated that configurations of the present invention can provide a single reforming system generating H₂ at a variable scale, dependent upon demand by separate or simultaneous operation of the subsystems in the integrated apparatus. Also, a compact reformer can be used because there is no N₂ dilution. The lack of N₂ dilution also results in easy and economical H₂ purification, and in many configurations, no PSA is required. Furthermore, in many configurations, high-pressure electrolysis eliminates the need for an O₂ compressor. For non-H₂ fueling station applications, one can still use the PSA but can eliminate the air or syngas compressor required by the PSA.

While the invention has been described in terms of various specific embodiments, those skilled in the art will recognize that the invention can be practiced with modification within the spirit and scope of the claims.

What is claimed is:

1. A method for producing hydrogen (H₂) comprising:
utilizing an electrolyzer to produce H₂ gas from steam;
mixing O₂ and steam byproducts of the electrolyzer with a hydrocarbon fuel;
utilizing a catalytic partial oxidation (CPO) reformer to produce CO and H₂ from the mixed byproducts and the hydrocarbon fuel; and
removing the CO and remaining steam from the produced CO and H₂, to thereby produce additional H₂.

2. A method in accordance with claim 1 wherein removing the CO and remaining steam further comprises utilizing a PrOₓ catalyst bed with a stream of O₂ produced by the electrolyzer to convert the CO to CO₂.

3. A method in accordance with claim 1 wherein removing the CO and remaining steam further comprises utilizing a shift reactor to convert CO and steam to CO₂ and H₂.

4. A method in accordance with claim 1 wherein the byproducts of the electrolyzer mixed with the hydrocarbon fuel comprise O₂ and steam.

5. A method in accordance with claim 1 wherein about 10% to 80% of a full scale load of the generated H₂ is generated by the electrolyzer.

6. A method in accordance with claim 1 further comprising utilizing excess steam and heat generated by the CPO reformer in the electrolyzer.

7. A method for producing hydrogen (H₂) comprising:
utilizing an electrolyzer to produce H₂ gas from steam;
utilizing byproducts of the electrolyzer as input to a catalytic partial oxidation (CPO) reformer to produce more H₂ and
utilizing steam and heat byproducts from the CPO reformer as input to the electrolyzer.

8. A method in accordance with claim 7 wherein about 10% to 80% of the hydrogen produced is generated by the electrolyzer.

9. A method in accordance with claim 7 further comprising condensing and removing H₂O and CO₂ as liquid, and compressing and storing generated H₂ at 5000-10,000 psi.

10. A method in accordance with claim 1 wherein the electrolyzer utilized is an electrolyzer selected from the group consisting of an electrolyzer utilizing liquid water electrolysis to supply O₂, a proton exchange membrane (PEM) stream electrolyzer supplying O₂ using steam at about 100° C. to 300° C., and a solid oxide electrolyzer (SOEC) supplying O₂ and using steam at about 600° C. and 800° C.

11. An apparatus for producing hydrogen (H₂) comprising:
an electrolyzer configured to produce H₂ gas from steam;
a catalytic partial oxidation (CPO) reformer coupled to said electrolyzer and configured to utilize byproducts of the electrolyzer as input to produce more H₂; and
said electrolyzer coupled to said CPO reformer to utilize steam and heat produced from the CPO reformer as input to the electrolyzer.

12. An apparatus in accordance with claim 11 wherein the electrolyzer is configured to produce about 10% to 80% of the hydrogen.

13. A method in accordance with claim 11 wherein the electrolyzer utilized is an electrolyzer selected from the group consisting of an electrolyzer utilizing liquid water electrolysis to supply O₂, a proton exchange membrane (PEM) stream electrolyzer supplying O₂ using steam at about 100° C. to 300° C., and a solid oxide electrolyzer (SOEC) supplying O₂ and using steam at about 600° C. and 800° C.

14. An apparatus in accordance with claim 11 further configured to condense and remove H₂O and CO₂ as liquid, and to compress and store generated H₂ at 5000-10,000 psi.

15. An apparatus in accordance with claim 11 further configured to:
mix byproducts of the electrolyzer with hydrocarbon fuel;
utilize the catalytic partial oxidation (CPO) reformer to produce CO and H₂ from the mixed byproducts and hydrocarbon fuel; and
remove the CO and remaining steam from the produced CO and H₂, to thereby produce additional H₂ from the apparatus.

16. An apparatus in accordance with claim 15 further comprising a PrOx catalyst bed configured to utilize a stream of O₂ to convert the CO to CO₂.

17. An apparatus in accordance with claim 15 further comprising a shift reactor to convert CO and H₂O to CO₂ and H₂.

18. An apparatus in accordance with claim 15 configured to mix O₂ and steam with the byproducts of the electrolyzer.

19. An apparatus in accordance with claim 15 wherein the electrolyzer is configured to generate about 10% to 80% of the H₂.

20. An apparatus in accordance with claim 15 wherein the electrolyzer further configured to utilize excess steam and heat generated by the CPO reformer.
